(19) United States
(12) Patent Application Publication
(10) Pub. No.: US 2009/0139922 A1
(43) Pub. Date: Jun. 4, 2009

(54) Transmission Filter System

(75) Inventors: Fredrick R. Poskie, Plymouth, MI (US); Scott H. Wittkopp, Ypsilanti, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 11/949,851

(22) Filed: Dec. 4, 2007

(51) Int. Cl. B01D 35/02; B01D 35/027

(52) U.S. Cl. 210/167.08; 210/172.3; 210/450

(57) ABSTRACT

A low profile transmission filter system is provided that is connectable between a transmission casing and an oil pan. The filter system includes a filter housing with an open bottom and a flange there around and forming a tubular opening opposite the open bottom. A seal member is secured along the flange and has two ends spaced from one another to define a gap there between. The seal member compresses against an inner surface of the oil pan when the oil pan is connected to the transmission casing to define a filter cavity within the filter housing with an inlet at the gap.

### TECHNICAL FIELD

The invention relates to a transmission filter system.

### BACKGROUND OF THE INVENTION

Transmissions have a multitude of moving components that need continual lubrication and cooling via transmission fluid or oil. Transmission oil is typically retained in an oil pan connected to the transmission casing. A filter is positioned between the oil and the casing to insure that transmission oil is filtered before reaching the transmission.

### SUMMARY OF THE INVENTION

A compact, low profile transmission filter system is provided. The transmission filter system is connected between a transmission casing and an oil pan for directing oil from the oil pan to the transmission casing. The transmission filter system includes a filter housing with an open bottom and a flange formed around the open bottom. The filter housing also has a tubular opening opposite the open bottom. A seal member is secured along the flange. The seal member has two ends spaced from one another to define a gap there between. The seal member compresses against an inner surface of the oil pan when the oil pan is connected to the transmission casing. A filter cavity is thereby defined within the filter housing with an inlet to the filter cavity at the gap and the seal member. Preferably, the filter housing is a unitary, one piece component. Because the filter housing seals directly to the inner surface of the oil pan, a separate bottom portion of the filter housing is not required, making the entire oil pan and transmission filter system assembly more compact, especially in overall height above the oil pan. When the oil pan is secured to the transmission casing, the filter housing partially defines a space between the transmission casing and an upper surface of the filter housing. A valve body is nested within the space and preferably is in contact with the upper surface of the filter housing to contribute to compression of the seal member against the inner surface of the oil pan. A filter is secured to the filter housing within the filter cavity between the tubular opening and the open bottom. The filter filters oil directed from the pan to the casing.

Preferably, but not necessarily, the oil pan may be formed to mate with the seal member to help ensure a sealed filter cavity. In one embodiment, the oil pan is formed with a recess that is matable with a seal member so that the seal member nests within the recess when the oil pan is connected to the transmission casing. In another embodiment, the oil pan is formed with protruding ridges that define a channel. The seal member nests within the channel when the oil pan is connected to the transmission casing.

Because the filter housing is a one-piece component with a seal member matable directly to the oil pan, a separate bottom housing portion secured to the oil pan and matable to the filter housing is not required. Thus a clearance between the transmission casing and the outer surface of the filter housing is maximized, permitting a valve body to be packaged between the filter housing and the casing when the oil pan is secured to the casing without necessarily increasing the depth of the bottom pan.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration in perspective view of a transmission filter system with a filter housing, seal and a first embodiment of a bottom pan;

FIG. 2 is a schematic illustration in schematic cross-sectional view of the transmission filter system of FIG. 1 taken at the arrows 2-2 shown in FIG. 1;

FIG. 3 is a schematic illustration in bottom view of the filter housing of FIG. 1;

FIG. 4 is a schematic illustration in plan view of a second embodiment of a bottom pan for use with the filter housing and seal of FIGS. 1 and 2; and

FIG. 5 is a schematic illustration in fragmentary cross-sectional view of the bottom pan of FIG. 4.

### DESCRIPTION OF THE PREFERRED EMBODIMENTS

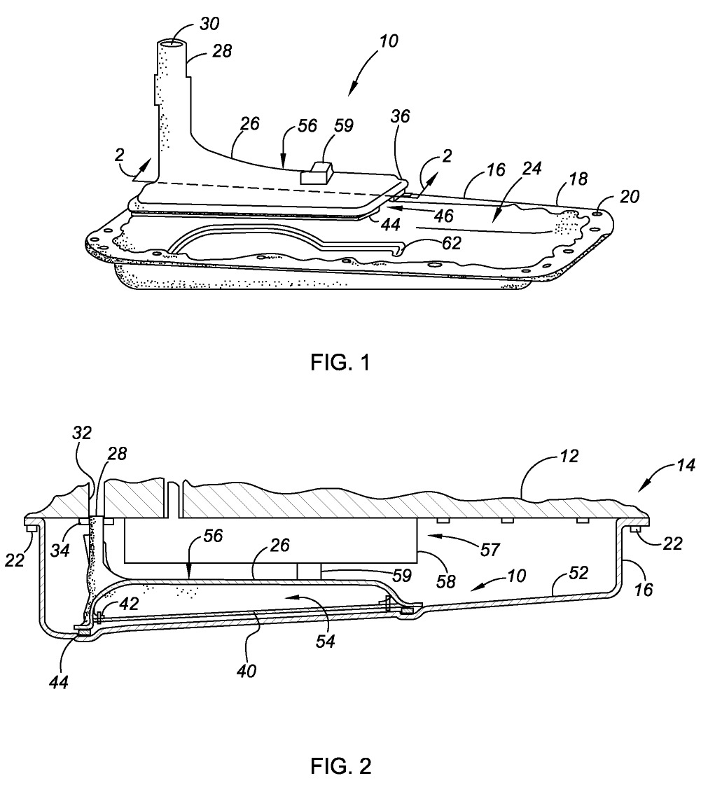

Referring to the drawings wherein like reference numbers refer to like components, FIG. 1 illustrates a transmission filter system 10 in partially exploded view (i.e., with a filter housing 26 shown above an oil pan 16, prior to connection thereto). In FIG. 2, the transmission filter system 10 is shown connected with a transmission casing 12 as part of a transmission 14 as will be described below. Referring again to FIG. 1, the transmission filter system 10 includes an oil pan 16 that is formed with a flange 18 configured for connection to the transmission casing 12. A multitude of fastener openings 20 are formed in the flange 18 and allow connection of the oil pan 16 to the transmission casing 12 via fasteners 22 as illustrated in FIG. 2. The oil pan 16 forms an oil pan cavity 24 which is capable of containing transmission oil (also referred to as transmission fluid).

The transmission filter system 10 also includes a filter housing 26 which is preferably a one piece, unitary component. The filter housing 26 includes a tubular neck portion 28 with a tubular opening 30. As illustrated in FIG. 2, the tubular neck portion 28 is configured to cooperate with an opening 32 in the transmission casing 12. A seal 34 is placed around the tubular opening to ensure a secure and leak free fit.

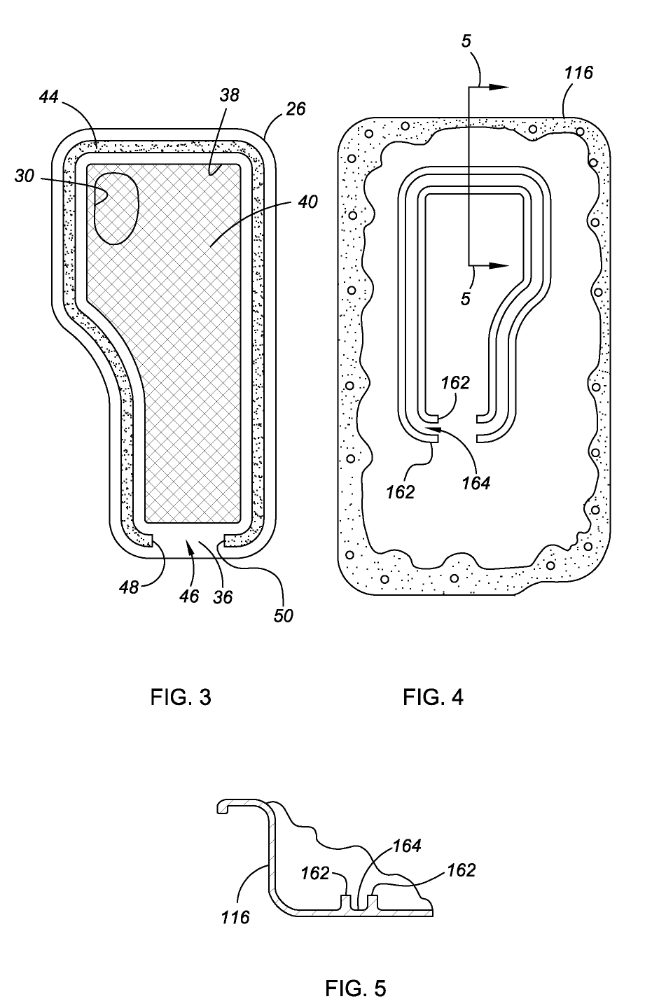

Referring again to FIG. 1, the filter housing 26 terminates in a peripheral flange 36. The peripheral flange 36 partially defines an open bottom or bottom opening 38 of the filter housing 26, as best illustrated in FIG. 3. FIG. 3 also illustrates a filter 40 connected to the filter housing 26 between the peripheral flange 36 and bottom opening 38 and the tubular opening 30. In FIG. 2, the filter 40 is shown fastened to tabs 42 extending inward from the filter housing 26. Any means of fastening the filter 40 to the filter housing 26 may be utilized.

Referring to FIGS. 1, 2 and 3, a seal member 44 is shown secured about the peripheral flange 36 of the filter housing 26. The seal member 44 is preferably a compressible elastomeric material which may be rectangular in cross section (as illustrated in FIG. 2). The seal member 44 is generally U-shaped in that it does not completely extend around the peripheral flange 36. Instead, a space or inlet 46 is defined between two ends 48, 50 of the seal member 44. As illustrated in FIG. 2, when the oil pan 16 is secured to the transmission casing 12 the filter housing 26 extends between the casing 12 and an inner surface 52 of the oil pan 16. The filter housing 26 is sized such that the seal member 44 can be compressed between the peripheral flange 36 and the inner surface 52 of the oil pan 16, thereby defining a sealed chamber or filter cavity 54 within the transmission housing 26. There is no additional housing portion or component between the seal member 44 and the inner surface 52 of the oil pan, thus ensuring a low profile of the upper surface 56. The upper surface 56 includes one or more extensions 59, sometimes referred to as a standoff, which supports the valve body 58. This permits a valve body 58 to nest between the filter housing 26 and the transmission casing 12 while minimizing the overall depth of the oil pan 16. The valve body 58 contains fluid passages and a plurality of electrohydraulic valves (not shown) that are controlled to direct pressurized fluid throughout the transmission 14, as is known. The surface area of the filter 40 is not compromised (i.e., is not decreased) with the low profile transmission filter system 10.

Referring again to FIGS. 1 and 2, the oil pan 16 is formed with a recess 62 that is configured to receive the seal member 44 when the oil pan 16 is connected to the casing 12. The recess 62 may be stamped into the pan during formation of the oil pan 16. In another embodiment of an oil pan shown in FIGS. 4 and 5, an oil pan 116 is illustrated as having protruding ridges 162 that form a channel 164 there between. The ridges 162 and channel 164 are configured to receive the seal member 44 of the transmission housing 26.

While the best modes for carrying out the invention have been described in detail, those familiar with the art to which this invention relates will recognize various alternative designs and embodiments for practicing the invention within the scope of the appended claims.

1. A low profile transmission filter system connected between a transmission casing and an oil pan for directing oil from the oil pan to the transmission casing, comprising:
a filter housing having an open bottom with a flange therearound and forming a tubular opening opposite the open bottom; and
a seal member secured along the flange and having two ends spaced from one another to define a gap therebetween;
wherein the seal member compresses against an inner surface of the oil pan when the oil pan is connected to the transmission casing to define a filter cavity within the filter housing with an inlet at the gap.

2. The low profile transmission filter system of claim 1, wherein the filter housing is a unitary, one-piece component.

3. The low profile transmission filter system of claim 1 in combination with a valve body for the transmission, wherein the filter housing is configured to partially define a space between the transmission casing and an upper surface of the filter housing when the oil pan is secured to the transmission casing; and wherein the valve body is nested within the space.

4. The low profile transmission filter system of claim 1, further comprising:
a filter secured to the filter housing within the filter cavity between the tubular opening and the open bottom to filter oil directed from the pan to the casing.

5. The low profile transmission filter system of claim 1, wherein the oil pan is formed with a recess matable with the seal member such that the seal member is within the recess when the oil pan is connected to the transmission casing.

6. The low profile transmission filter system of claim 1, wherein the oil pan is formed with protruding ridges defining a channel; and wherein the seal member is nested in the channel when the oil pan is connected to the transmission casing.

7. A transmission filter system adapted for connection to a transmission casing comprising:
an oil pan with a flange; wherein the oil pan is adapted for connection to the casing at the flange to define a pan cavity;
a filter housing with a tubular neck portion operatively connectable to the casing; wherein the filter housing terminates in a peripheral flange opposite the tubular neck portion;
a filter supported by the filter housing between the neck portion and the flange;
a seal member having two ends and connected to the filter housing partway around the peripheral flange and defining a gap between the two ends; and
wherein the filter housing is contained within the pan cavity between the casing and the oil pan when the oil pan is connected to the casing to compress the seal member against the oil pan, the filter housing and seal member thereby defining a sealed chamber within the oil pan with the gap as an inlet to allow oil flow from the oil pan through filter and neck portion to the casing.

8. The transmission filter system of claim 7, wherein the oil pan is formed with a recess configured to receive the seal member when the oil pan is connected to the casing.

9. The transmission filter system of claim 7, wherein the oil pan is formed with protruding ridges configured to receive the seal member between the ridges when the oil pan is connected to the casing.

10. The transmission filter system of claim 7, wherein the filter housing is a one-piece component.

11. A transmission comprising:
a transmission casing;
an oil pan connected to the transmission casing and defining an oil pan cavity for containing lubrication oil for the transmission;
a filter housing within the oil pan cavity and having an open bottom and tapering to a neck opening with a filter supported between the open bottom and the neck opening; and
a seal member adhered to the filter housing substantially encircling the open bottom; wherein the seal member is compressed between the oil pan and the filter housing when the oil pan is mated to the transmission casing.

12. The transmission of claim 11, wherein the seal member has two spaced ends defining a gap; wherein the gap forms an inlet permitting fluid communication between the oil pan cavity and the filter.
